(19) United States
(12) Patent Application Publication
(10) Pub. No.: US 2002/0073709 A1
(43) Pub. Date: Jun. 20, 2002

(54) GAS ONLY NOZZLE

(75) Inventors: William Theodore Bechtel, Scotia, NY (US); David Orus Fitts, Ballston Spa, NY (US); Guy Wayne DeLeonardo, Glenville, NY (US)

Correspondence Address: NIXON & VANDERHYE P.C., 8th Floor, 1100 North Glebe Road, Arlington, VA, 22201-4714, US

(73) Assignee: General Electric Company

(21) Appl. No.: 09/994,830

(22) Filed: Nov. 28, 2001

Related U.S. Application Data
(62) Division of application No. 09/652,176, filed on Aug. 31, 2000.

(51) Int. Cl. F02C 7/00

(52) U.S. Cl. 60/740

(57) ABSTRACT

A diffusion flame nozzle gas tip is provided to convert a dual fuel nozzle to a gas only nozzle. The nozzle tip diverts compressor discharge air from the passage feeding the diffusion nozzle air swirl vanes to a region vacated by removal of the dual fuel components, so that the diverted compressor discharge air can flow to and through effusion holes in the end cap plate of the nozzle tip. In a preferred embodiment, the nozzle gas tip defines a cavity for receiving the compressor discharge air from a peripheral passage of the nozzle for flow through the effusion openings defined in the end cap plate.

This Invention was made with Government support under Contract No. DE-FC21-95MC31176 awarded by the Department of Energy. The Government has certain rights in this invention.

### BACKGROUND OF THE INVENTION

The invention relates to a fuel nozzle and more particularly to an end cap plate of a “Dual Fuel” nozzle design that has been configured for gas only use and to an adaptation for cooling the same.

Gas turbines for power generation are generally available with fuel nozzles configured for either “Dual Fuel” or “Gas Only”. “Gas Only” refers to operation burning, for example, natural gas and “Dual Fuel” refers to having the capability of operation burning either natural gas or liquid fuel. The dual fuel configuration is generally applied with oil used as a backup fuel, if natural gas is unavailable. The gas only configuration is offered in order to reduce costs as the nozzle parts and all associated equipment required for liquid fuel operation are not supplied. In general, fuel nozzles are designed to have dual fuel capability and the gas only version is a modification to the dual fuel design in which the dual fuel parts, which include the oil, atomizing air and water passages, are removed from the nozzle. The removal of these components exposes a cylindrical, open region along the axial center line of the nozzle to hot combustion gas. An example of a dual fuel nozzle modified to remove the dual (liquid) fuel parts is illustrated in FIG. 1. This nozzle is disclosed in detail in copending application Ser. No. 09/021,081, filed Feb. 10, 1998, the entire disclosure of which is incorporated herein by this reference.

FIG. 1 is a cross-section through the burner assembly. The burner assembly is divided into four regions by function including an inlet flow conditioner 7, an air swirler assembly with natural gas fuel injection (referred to as a nozzle assembly) 2, an annular fuel air mixing passage 3, and a central diffusion flame natural gas fuel swozzle assembly 13.

Air enters the burner from a high pressure plenum 5, which surrounds the entire assembly except the discharge end, which enters the combustor reaction zone 6. Most of the air for combustion enters the premixer via the inlet flow conditioner (IFC) 7. The IFC includes an annular flow passage 8 that is bounded by a solid cylindrical inner wall 9 at the inside diameter, a perforated cylindrical outer wall 10 at the outside diameter, and a perforated end cap 11 at the upstream end. In the center of the flow passage 8 is one or more annular turning vanes 12. Premixer air enters the IFC 7 via the perforations in the end cap 11 and the cylindrical outer wall 10.

At the center of the burner assembly is a conventional diffusion flame fuel nozzle tip 13 having a slotted gas tip 14, which receives combustion air from an annular passage 15 and natural gas fuel through gas holes 16. The body of this fuel nozzle includes a bellows 17 to compensate for differential thermal expansions between this nozzle and the premixer. In the center of this diffusion flame fuel nozzle is a cavity 18, which, as noted above, receives the liquid fuel assembly to provide dual fuel capability. In the dual fuel configuration, during gas fuel operation, the oil, atomizing air and water passages in this region are purged with cool air to block hot gas from entering the passages when not in use. When the nozzle is configured for gas only operation, cavity 18 must be capped at the distal end of the nozzle to block hot combustion gas from entering the center, open region which may result in mechanical damage due to the high temperature. Since the end cap plate is exposed to hot combustion gas, it must be cooled.

In the past, cooling of the end cap plate used to cover the open region at the nozzle tip in a conversion from a dual fuel to a gas only configuration has been accomplished using the gas fuel as the cooling medium. More specifically, because removal of the dual fuel components eliminates the structure that formed the inner wall of the gas fuel passage, a part of the gas fuel can effuse through tiny holes in the end cap plate (not shown in FIG. 1) to cool the same while the bulk of the fuel passes through the normal gas hole injectors 16 which are located between the air swirler vanes. This is a very simplified design for converting from a dual fuel to gas only nozzle. While generally effective, this approach is undesirable in view of the need to maintain low emissions over the gas turbine operating range. Diverting gas fuel for cooling from the desired injection points between the air swirler vanes and injecting that gas at a different location through tiny holes in an end cap plate (not shown in FIG. 1) for cooling reduces the premixing of gas fuel and air which is essential for low emissions performance.

Another possible method for cooling the end cap plate is to use the cooling air supplied from the nozzle purge air system. The nozzle purge air system supplies air cooled so that its temperature does not exceed 750° F. As briefly described above with reference to purging the liquid fuel components during gas fuel operation, this air is generally applied to purging the gas fuel passages when not in use to resist the back-flow of hot combustion gas into the gas passages, manifolds and pipings. The limit of not exceeding an air temperature of 750° F. relates to the possible auto-ignition of gas fuel coming into contact with air exceeding that temperature. Since an end cap plate passage adapted to receive purge air for cooling rather than gas fuel would never have gas fuel present, it would be inefficient to use specially cooled air from the nozzle purge system to cool an end cap plate.

### BRIEF SUMMARY OF THE INVENTION

The existing fuel nozzle purge system does not have the capacity to supply the additional amount of air required for cooling the gas only nozzle end cap plate, nor would such a use of that specially cooled air be efficient.

It has been determined, however, that compressor discharge air would be an adequate cooling medium. Thus, a diffusion flame nozzle gas tip has been designed to allow for the use of compressor discharge air to cool the end cap plate. The appropriate amount of compressor discharge air is extracted from annular passage 15 into the central region 18 and is emitted through tiny (effusion) holes in the end cap plate to produce the desired cooling.

Thus, the invention is embodied in a method for cooling the end cap plate of a gas only fuel nozzle in which compressor discharge air is supplied as the cooling medium. The method of the invention advantageously replaces the requirement to use either cooling air from the existing nozzle purge system or gas fuel as the cooling medium. In accordance with an embodiment of the invention, this is accomplished by providing a diffusion flame nozzle gas tip that diverts compressor discharge air from the passage feeding the diffusion nozzle air swirl vanes to the cavity vacated by removal of the dual fuel components so that the diverted compressor discharge air can flow to and through effusion holes in the end cap plate. In a preferred embodiment, the nozzle gas tip defines a cavity for receiving the compressor discharge air from a peripheral passage of the nozzle for flow through the effusion openings defined in the end cap tip.

### BRIEF DESCRIPTION OF THE DRAWINGS

FIG. 1 is an isometric view of a fuel nozzle with the liquid fuel parts removed from the center portion of the nozzle; and

FIG. 2 is a cross-sectional view of a diffusion gas tip for a gas only nozzle that embodies the invention;

### DETAILED DESCRIPTION OF THE INVENTION

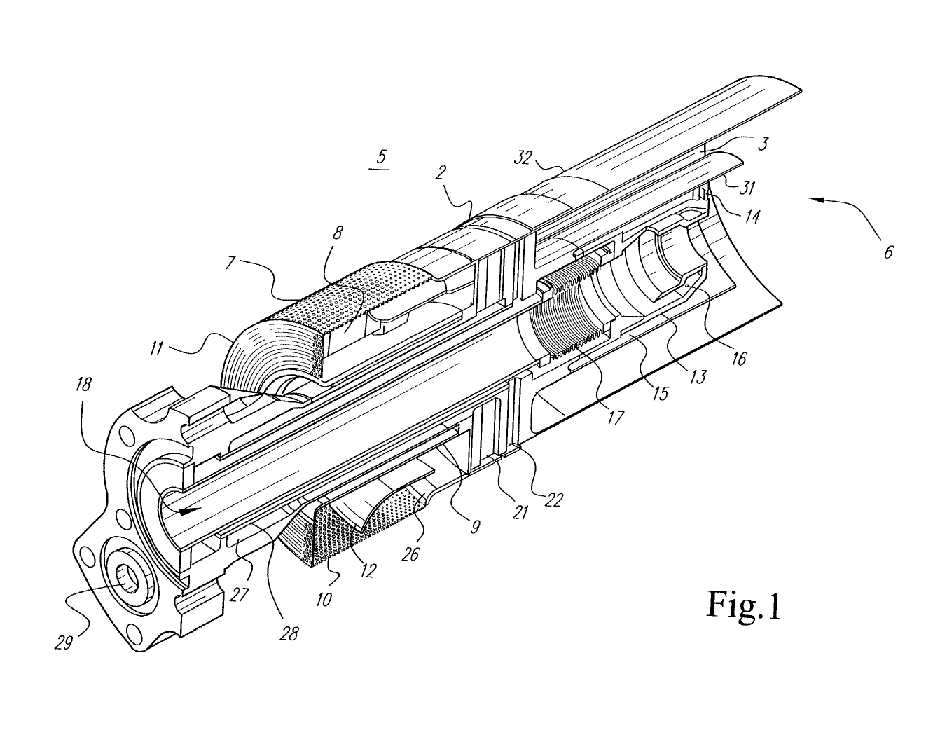

As described above, FIG. 1 is an isometric view of a fuel nozzle with the liquid fuel parts removed from the center portion of the nozzle. With the liquid fuel parts of the dual fuel nozzle removed for the gas only configuration, the cavity must be closed at the distal end in order to preclude hot combustion gas from flowing into this region and to direct the gas fuel to and through the gas holes.

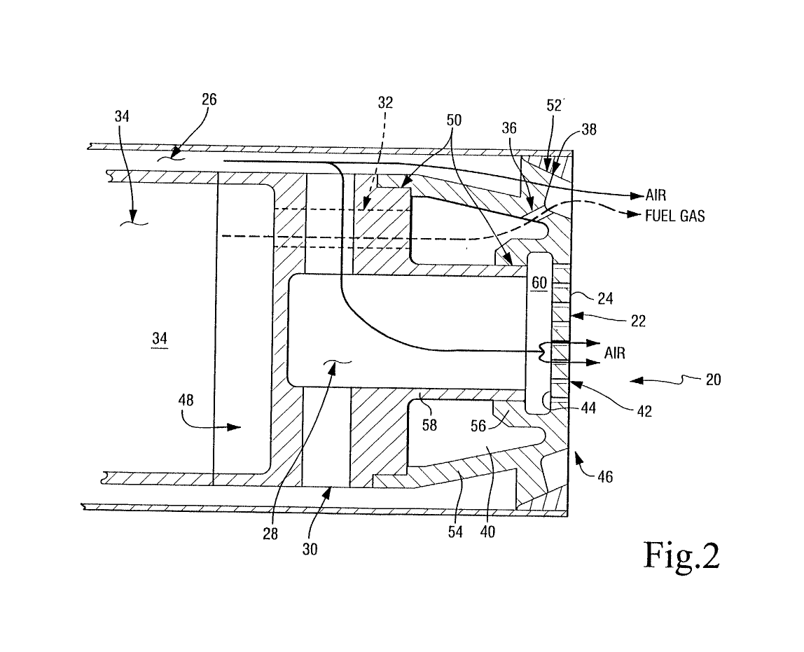

With reference to FIG. 2, an embodiment of a diffusion gas tip 20 specifically for the gas only nozzle of the invention is shown. End cap plate 22 which closes the cavity formed by removal of the liquid fuel parts must be cooled because its distal surface 24 is exposed to hot combustion gas. To cool the end cap plate, compressor discharge air is diverted from annular channel 26, which feeds air through the diffusion air swirl vanes, and directed into a cavity 28 defined behind the end cap plate 22. In the illustrated embodiment, four circular, radial holes 30 transfer the compressor discharge air from annular outer passage 26 to inner cavity 28. Moreover, in the illustrated embodiment, these four radial cooling air transfer passages 30 are equally spaced circumferentially of the cavity 28 and are preferably equally spaced between the axial gas fuel passages 32 that transfer gas from the center nozzle cavity 34 to the gas injection holes 36 in the air swirl vanes 38. In the illustrated embodiment, an annular gas plenum 40 receives the gas from gas passages 32 for distribution to gas injection holes 36. The size of passages 30 and their orientation relative to the longitudinal axis of the nozzle may be varied as deemed necessary or desirable to determine the amount of compressor bleed air diverted toward cavity 28, it being understood, however, that the primary limiting factor with respect to cooling air flow would be the effusion openings 42 of the end cap plate 22, which will determine the volume of flow therethrough.

In the central air cavity 28, air received through passages 30 is directed to flow through small effusion holes 42 in the end cap plate 22, thereby cooling not only the proximal surface 44 of the end cap plate 22, but also to enhance the cooling of the entire plate structure. It is to be appreciated that the amount of compressor discharge air diverted for the end cap plate cooling represents only a very small percentage of that passing through the annular passage 26 that feeds the diffusion nozzle air swirl vanes 38.

In the illustrated embodiment, the nozzle tip is comprised of a tip part 46 and a flow diverter part 48. The diverter part 48 is secured to the tip part 46 as by brazed joints shown at 50. The tip part 46 is in turn brazed to the nozzle structure as at 52. The tip part 46 defines the end cap plate 22, the diffusion nozzle swirl vanes 38, an outer peripheral wall 54 of gas plenum 40, and a receiver 56 for receiving a cavity defining wall 58 of the diverter part 48. In the illustrated embodiment, the tip part 46 defines a distal portion 60 of the cavity 27. The flow diverter part 48 defines a remainder of the cavity 28, compressor bleed air diverting passages 30 for diverting air to cavity 28 for cooling the end cap plate 22 and the axial passages 32 for gas fuel flow from the center nozzle cavity 34 to and through the fuel injection holes 36.

As will be appreciated, the above described diffusion gas tip allows for the use of compressor discharge air to cool the end cap plate on the distal tip of the gas only fuel nozzle and replaces the use of either gas fuel or cooled air from the existing nozzle air purge system for this function. Also, the invention advantageously requires modification of only the diffusion tip sub-assembly to convert from a dual fuel to a gas only fuel nozzle design. The impact of this modification for the gas only nozzle would not be expected to substantially alter the gas fuel operational characteristics of the nozzle from the gas only mode of the dual fuel configuration.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A nozzle fuel tip for converting a dual fuel nozzle to a gas only nozzle configuration comprising:
an end cap plate structure having a distal surface, a proximal surface, and a plurality of openings defined therethrough for cooling fluid flow, and
a cavity defining structure disposed proximal to said proximal surface of said end cap plate for defining an air cavity proximal to and in flow communication with said openings, said cavity defining structure further including a plurality of cooling air passages extending from an outer peripheral surface thereof to said cavity for the flow of cooling air from said outer peripheral surface to said cavity and a plurality of gas fuel passages extending from a proximal end of said cavity defining structure to a distal end of said cavity defining structure so as to substantially isolate said air cavity from said fuel flow.

2. A nozzle fuel tip as in claim 1, further comprising a wall disposed peripherally of said cavity defining structure and spaced therefrom to define a gas plenum therebetween for receiving and distributing gas fuel flow flowing thereto through said gas fuel passages.

3. A nozzle fuel tip as in claim 2, further comprising a plurality of gas injection holes defined about a periphery of said end cap plate for directing gas fuel from said gas fuel plenum generally distally.

4. A nozzle as in claim 1, composed of a tip part and a diverter part, said tip part comprising said end cap plate and said diverter part comprising said cavity defining structure.

5. A nozzle as in claim 4, wherein said tip part and said diverter part are brazed so as to be fixedly secured as an integrated unit.

6. A nozzle as in claim 1, wherein there are four said cooling air passages.

7. A nozzle as in claim 6, wherein there are four said gas fuel passages, a gas fuel passage being disposed between adjacent said cooling air passages.

8. A nozzle as in claim 1, wherein said gas fuel passages extend in a direction generally parallel to a longitudinal axis of said nozzle.

9. A nozzle as in claim 1, wherein said cooling air passages are oriented in a direction generally transverse to a longitudinal axis of said nozzle so that said passages each extend generally radially with respect to said longitudinal axis.

10. A gas only nozzle comprising:
an outer peripheral wall;
an air flow passage defined within said outer wall and extending at least part circumferentially thereof;
a central gas fuel flow passage; and
a nozzle tip fixed with respect to said outer peripheral wall at a distal end thereof for substantially closing said central gas flow passage, said nozzle tip including an end cap plate; said nozzle tip defining at least one cooling air passage for diverting a portion of the air flowing through said air flow passage to cool the nozzle end cap plate thereof and said nozzle tip defining at least one gas fuel passage for directing gas fuel flowing through said central gas flow passage to and through gas injection holes defined about a periphery of said nozzle end cap plate.

11. A gas only nozzle as in claim 10, wherein a plurality of fluid flow openings are defined through said end cap plate for flowing cooling air therethrough.

12. A gas only nozzle as in claim 10, wherein said nozzle tip includes a cavity defining structure disposed adjacent to a proximal surface of said nozzle end cap plate for defining an air cavity adjacent to said nozzle end cap plate, said cavity defining structure defining said at least one cooling air passage and said at least one gas fuel passage.

13. A gas only nozzle as in claim 10, further comprising a wall disposed peripherally of said cavity defining structure and spaced therefrom to define a gas plenum therebetween for receiving and distributing gas fuel flow flowing thereto through said at least one gas fuel passage.

14. A gas only nozzle as in claim 12, wherein said nozzle tip is composed of a tip part and a diverter part, said tip part comprising said end cap plate and said diverter part comprising said cavity defining structure.

15. A gas only nozzle as in claim 14, wherein said tip part and said diverter part are brazed so as to be fixedly secured as an integrated unit.

16. A gas only nozzle as in claim 10, wherein said at least one gas fuel passage extends in a direction generally parallel to a longitudinal axis of said nozzle and wherein said at least one cooling air passage is oriented in a direction generally transverse to a longitudinal axis of said nozzle so as to extend generally radially with respect to said longitudinal axis.

17. A method of cooling a gas only nozzle fuel tip, comprising:
providing a gas only nozzle including an outer peripheral wall; an air flow passage defined within said outer wall and extending at least part circumferentially thereof; and a central gas fuel flow passage;
securing a nozzle tip to said outer peripheral wall at a distal end thereof to substantially close said central gas flow passage, said nozzle tip including an end cap plate;
diverting gas fuel flowing through said central gas fuel flow passage to flow to and through gas injection holes defined about a periphery of said end cap plate; and
diverting a portion of the air flowing through said air flow passage to flow to said end cap plate to cool the same.

18. A method as in claim 17, wherein the air flowing through the nozzle is compressor bleed air.

19. A method as in claim 17, wherein there are a plurality of openings defined through said end cap plate, and said step of diverting air comprises diverting air to flow to and through said openings in said end cap plate.
